(19) United States
(12) Patent Application Publication
(10) Pub. No.: US 2003/0150870 A1
(43) Pub. Date: Aug. 14, 2003

(54) UNIVERSAL VENDING MACHINE

(76) Inventor: Allan Gilbert, Boxford, MA (US)

Correspondence Address: Allan Z. Gilbert, 3 Burning Bush Drive, Boxford, MA, 01921, US

(21) Appl. No.: 10/074,986

(22) Filed: Feb. 13, 2002

(51) Int. Cl. B65G 59/00; G07F 11/00; B65H 3/44

(52) U.S. Cl. 221/124

(57) ABSTRACT

A machine for dispensing substantially cylindrical items such as bottles, cans and containers of various shapes and sizes without making special adaptations to the machine. The machine includes a storage cabinet having a plurality of storage racks supported therein each of which includes a plurality of storage tracks formed by first and second elongate planar surfaces which are disposed substantially perpendicular to each other and which are inclined in a downwardly direction from the back of the storage rack toward the front of the storage rack. Each of the elongate planar surfaces is disposed at an acute angle to a horizontal plane disposed substantially parallel to the ground and each of the storage tracks is operable to support a plurality of items to be dispensed with the bottom surface of the items supported on one of the first and second elongate planar surfaces and a side cylindrical surface of the item being rollingly supported on the other of the first and second elongate planar surfaces.

### RELATED APPLICATIONS

NONE

### BACKGROUND OF THE INVENTION

### DESCRIPTION-TECHNICAL FIELD

The present invention relates to machines for vending and/or dispensing items such as bottles, cans and/or containers which include a substantially cylindrical side surface and a substantially flat bottom surface disposed substantially perpendicular to the side surface and more particularly to a simple, low cost machine for dispensing and/or vending a wide variety of different shaped items without modification of the vending machine. The vending machine includes a storage cabinet and a plurality of storage racks supported in the storage cabinet for storing and supporting items to be dispensed. Each of the storage racks includes a front, a back and a plurality of substantially parallel storage tracks located therein with each storage track being formed by first and second elongate planar surfaces which are disposed substantially perpendicular to each other and which are inclined in a downwardly direction from the back of the storage rack toward the front of the storage rack with each of the first and second elongate planar surfaces being disposed at an acute angle to a horizontal plane disposed substantially parallel to the ground. Each of the storage tracks is operable to support a plurality of the items to be dispensed with the flat bottom surface of the item supported on one of the first and second elongate planar surfaces and the cylindrical side surface of the item being rollingly supported on the other of the first and second elongate planar surfaces. A stop member may be located at the end of each of the storage tracks adjacent the front of the storage rack to prevent items to be dispensed from rolling from said storage track under the influence of gravity. The construction of the storage rack and plurality of storage tracks allow the dispensing of a large number of generally cylindrical containers of various shapes and sizes without making special adaptations to the machine and/or storage rack.

### BACKGROUND OF THE INVENTION

Machines are well known for vending or dispensing generally cylindrical items such as bottled and/or canned drinks and other items such as canned potato chips and pretzels. Many of the known prior art vending machines are expensive and are limited to dispensing containers of a particular size and shape. The variety of products to be vended or dispensed is evolving constantly as new products are introduced to the market. In a typical vending machine for vending beverages and other items, a large variety of milk, juices, teas, sodas, water and so on are desired to be vended. These products are presented in a wide variety of cans, glass bottles, plastic bottles and other containers. The manufacturers of the products try to distinguish their line from other lines by designing their own unique containers to gain maximum merchandising capability at the point of sale. Because of all of the shapes and sizes of today's containers, no vending machine presently on the market can vend all of the shapes and sizes of generally cylindrical containers without making special adaptations. These adaptations prove costly and cumbersome and do not always work well.

Although there are a vast array of different size and shaped containers in the market, the overwhelming majority are substantially cylindrical in shape and have a substantially flat bottom which is disposed substantially perpendicular to the cylindrical side surface of the container. The machine of the present invention is adapted to vend various product containers which have a flat bottom and a substantially cylindrical side surface regardless of the width or combination of vertical curves which form the cylindrical side surface. While the containers are described as having a flat bottom, in practice, a flat surface which can either be continuous or composed of a plurality of spaced apart flat surfaces is generally provided on most vendable cylindrical containers. The “flat” surface allows the containers to stand in a vertical orientation on a flat horizontal shelf.

The present invention overcomes the problems with the prior art by providing a storage rack including a plurality of storage tracks with each storage track being formed by first and second elongate planar surfaces which are disposed substantially perpendicular to each other and which are inclined in a downwardly direction from the back of the storage rack to the front of the storage rack with each of the first and second elongate planar surfaces being disposed at an acute angle to a horizontal plane disposed parallel to the ground. The items or containers to be dispensed lay on their substantially cylindrical side surface and roll in the storage track from back to front due to the incline in the storage rack. The container is able to roll straight, regardless of the shape of the cylindrical side surface because the flat container bottom rests and is registered on one of the elongate planar surfaces. The construction of the storage tracks enables substantially cylindrical containers of various shapes and sizes to be accommodated therein without modification or adjustment of the storage tracks and even allows containers of various shapes to be mixed and vended from the same storage track.

### SUMMARY OF INVENTION

The present invention provides a simple, low cost vending or merchandising machine for dispensing bottles and/or containers each of which has a substantially cylindrical side surface and a substantially flat bottom surface disposed substantially perpendicular to the side surface. The machine includes a storage cabinet having a plurality of storage racks disposed therein with each of the storage racks having a front, a back and a plurality of substantially parallel storage tracks located therein with each storage track being formed by a first and second elongate planar surface which are disposed substantially perpendicular to each other and which are inclined in a downwardly direction from the back of the storage rack toward the front of the storage rack with each of the first and second elongate planar surfaces being disposed at an acute angle to a horizontal plane disposed parallel to the ground. Each of the storage tracks is operable to support a plurality of containers to be dispensed with the flat bottom surface of the containers supported on one of the first and second elongate planar surfaces and the cylindrical side surface of the container being rollingly supported on the other of the first and second elongate planar surfaces.

The present invention provides a new and improved storage rack for supporting a plurality of items to be dispensed each of which includes a substantially cylindrical side surface and a substantially flat bottom surface disposed substantially perpendicular to the cylindrical side surface. The storage rack includes a front, a back and a plurality of substantially parallel storage tracks extending from the back of the storage rack to the front of the storage rack and each of which is inclined in a downwardly direction from the back of the storage rack to the front of the storage rack. Each of the plurality of storage tracks includes a first elongate planar surface and a second elongate planar surface disposed substantially perpendicular to the first elongate planar surface with the first and second planar surfaces being inclined in a downwardly direction from the back of the storage rack to the front of the storage rack and wherein the first and second planar surfaces each form an acute angle with a horizontal plane parallel to the ground. A stop member is located at the end of each of the tracks adjacent to the front of the storage rack. Each of the parallel storage tracks are operable to support a plurality of items to be dispensed with the substantially cylindrical side surface of each item being rollingly supported on the first planar surface of the track and the bottom surface of each item being supported on the second planar surface. Each of the items to be dispensed is supported in the storage track and rolls on its cylindrical side surface in a downwardly direction from the back of the storage rack to the front of the storage rack where the item engages with a stop member to prevent the item from rolling from the front of the storage rack.

A further improvement of the present invention is to provide a new and improved storage rack as set forth in the preceding paragraph wherein the first elongate planar surfaces of adjacent storage tracks in the storage rack are disposed substantially parallel to each other and spaced apart a distance greater than the maximum diameter of the substantially cylindrical side surface of the items to be dispensed.

### BRIEF DESCRIPTION OF THE DRAWINGS

FIG. 1 is a front perspective view of a vending machine constructed in accordance with the present invention showing the front door in its open position and more fully illustrating the storage racks.

FIG. 2 is a perspective view of one of the storage racks in which various shaped substantially cylindrical items to be vended have been placed.

FIG. 3 is a front view of the storage rack of FIG. 2.

FIG. 4 is a front view of an alternate embodiment of a storage rack of the present invention.

FIG. 5 is a side view of one of the stop members.

FIG. 6 is an enlarged fragmentary perspective view more fully illustrating the front end of the one of the storage tracks, the stop member and the latch for latching the stop member in its locked position.

FIG. 7 is a side partially cross sectioned view taken approximately along lines 7-7 of FIG. 3 of latch member in its latched position engaging with the stop member.

FIG. 8 is a side view similar to FIG. 7 illustrating the latch member in its retracted position wherein the stop member has rotated in a counterclockwise direction from its position illustrated in FIG. 7 and the item to be dispensed has now engaged the second radial surface on the stop member.

FIG. 9 is a side view similar to FIG. 8 illustrating the item to be dispensed moving from the front of the storage track toward the dispensing station, the latch member in its latching position and the next item to be dispensed engaging with the stop member to prevent movement of the next item to be dispensed from the storage rack.

FIG. 10 is a side view of an alternate embodiment of a stop member for utilization in a machine for dispensing items.

FIG. 11 is a front view of the embodiment illustrated in FIG. 10 taken approximately along the lines 11-11 of FIG. 10.

FIG. 12 is a bottom view of stop member and latch for latching the stop member taken approximately along the lines 12-12 of FIG. 9.

### DESCRIPTION OF THE PREFERRED EMBODIMENT

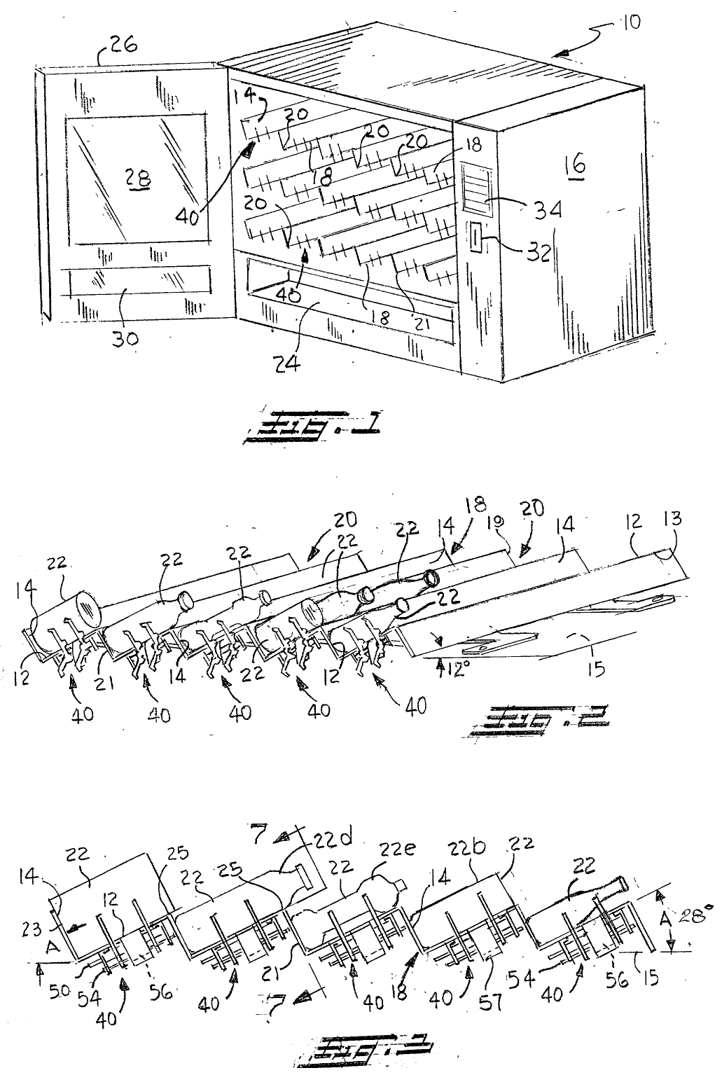

Referring to the figures and more particularly to FIG. 1 a vending machine 10, constructed in accordance with the present invention, is illustrated. The vending machine includes a cabinet 16 in which a plurality of substantially parallel storage racks 18 are supported. Each of the storage racks 18 include a plurality of substantially parallel storage tracks 20 each of which is operable to support a plurality of items 22 to be dispensed. A dispensing station 24 is disposed in the lower portion of the storage cabinet 16. The storage cabinet includes a door 26 on the front of the storage cabinet 16 which can be opened to provide access to the interior of the storage cabinet in a well known manner. The door 26, illustrated in its open position in FIG. 1, includes a window 28 for viewing the items to be dispensed when the door 26 is in its closed position and an opening 30 which can be used to access the dispensing station 24 in a well known manner when the door 26 is in its closed position.

A coin or credit mechanism 32 is located on the front of the storage cabinet 16 and is associated with a keypad 34 for selecting a particular selection to be vended from the storage racks 18 of the vending machine 10. The crediting mechanism 32 can be a coin mechanism or other type of crediting mechanism such as those that receive credit cards or dollar bills. When a proper credit is received, the keypad 34 is actuated to select an item to be vended and the selected product 22 is then dropped from one of the storage tracks 20 of the storage rack 18 to the dispensing station 24 where the product is removed from the machine 10. Each of the storage tracks 20 in the storage rack 18 will include an associated designation (such as A, B, C or 1, 2, 3, etc.) which can be entered into the keypad 34 to select the desired selection in a well known manner.

Each of the storage racks 18 is supported in the storage cabinet 16 in an inclined position with an incline of approximately 28 degrees, as is illustrated in FIG. 2, from a horizontal plane 15 located substantially parallel to the earth. Each of the storage racks 18 is inclined in a downwardly direction from the back 19 of each of the storage racks to the front 21 of each of the storage racks 18. Each of the plurality of storage tracks 20 are disposed substantially parallel to each other in the storage rack 18 and are inclined approximately 12 degrees from the horizontal in a downwardly direction from the back 19 toward the front 21 of the storage rack 18. When a plurality of items 22 to be dispensed are loaded in the storage tracks 20 the incline causes the items 22 to roll under the influence of gravity from the back 19 of the storage rack 18 toward the front 21.

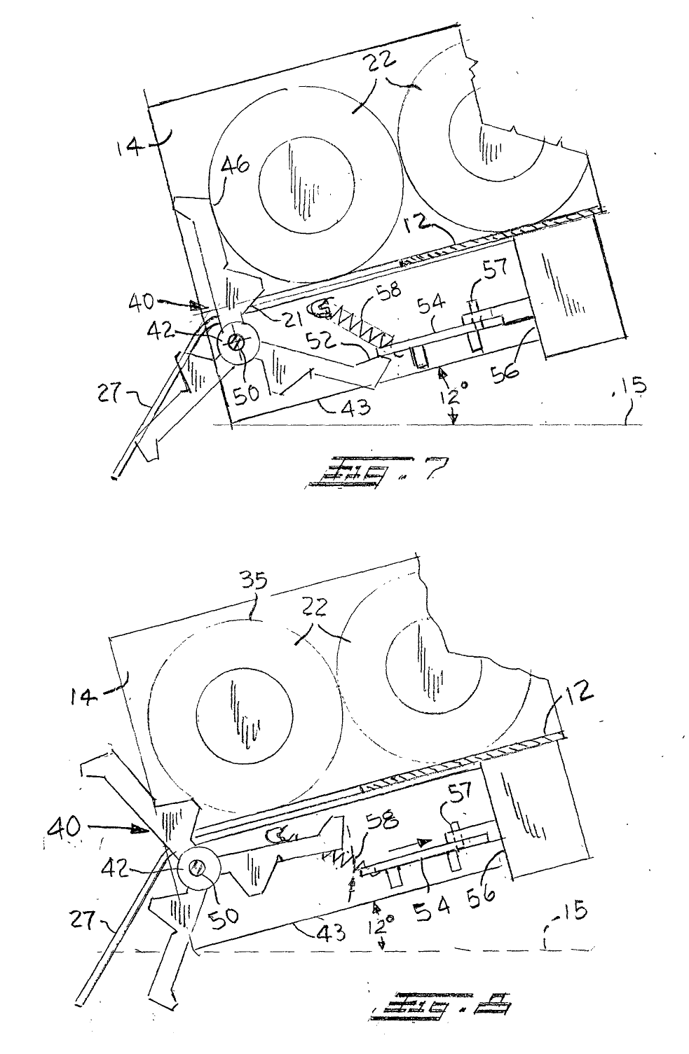

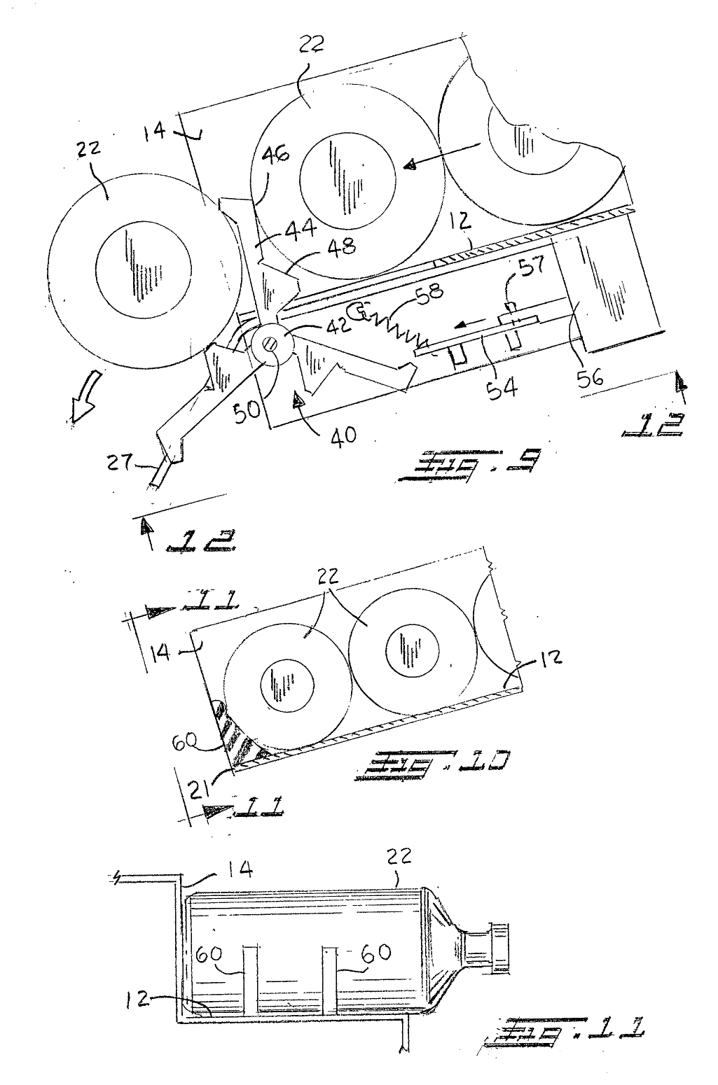

A stop member or mechanism 40, more fully illustrated in FIGS. 5-12, is provided for engaging with the items 22 to prevent the items 22 from rolling under the influence of gravity from the storage tracks 20 off of the front 21 of the storage rack 18. Each of the stop mechanisms 40, illustrated in FIGS. 5-9 and 12, include a pair of stop members 42, more fully illustrated in FIG. 5, which include a plurality of stop arms 44. Each of the stop members 42 is rotatable about an axis 50 which is supported on the bottom surface of the storage rack 18 by support member 43 which is secured to the bottom of storage rack 18. Each of the stop members 42 include three stop arms 44 spaced apart approximately 120 degrees about the axis 50. Each of the stop arms 44 includes a first stop surface 46 which is operable to initially engage with the items 22 to be dispensed to prevent the items from moving from the storage rack 18 under the influence of gravity. A second surface 48 is disposed on each of the arms 44 for engagement with the item 22 to be dispensed as stop member 42 rotates from its stop position, disclosed in FIG. 6 in which the surface 46 of stop member 42 engages with the next item 22 to be dispensed to prevent the item from rolling from the storage rack 18. A third surface 49 is disposed on each of the arms 44 and engages with the item 22 to be dispensed as item moves to its position disclosed in FIG. 8 as the stop member 42 rotates to its dispensing position in which the stop member 42 rotates approximately 120 degrees in a counter clockwise direction as viewed in FIGS. 8 and 9 to allow a single item 22 to be dispensed from a selected storage track 20.

A latch 54 is operable to engage with surface 52 on the stop member 42 to prohibit rotation of the stop member 42 about axis 50 and prohibit items 22 from rolling from the track 20. The latch 54 is supported for linear movement by support member 43 between its latched position, illustrated in FIGS. 6 and 7, and its retracted position, illustrated in FIG. 8. A solenoid 56 is operatively connected by link 57 to the latch member 54 for retracting latch member 54 in response to energization of solenoid 56. When latch 54 is retracted from its position illustrated in FIG. 7 to its position illustrated in FIG. 8, the latch member 54 disengages with the surface 52 on the stop member 42 to allow stop member 42 to rotate freely about axis 50. When latch 54 is retracted, the next item 22 to be dispensed disposed in the storage track 20 will roll, under the influence of gravity, and engage with surface 46 of stop member 42 to cause stop member 42 to rotate in a counterclockwise direction as is viewed in FIGS. 5-9. The item 22 to be dispensed initially engages with surface 46 of the stop member 42 to cause stop member 42 to rotate. As stop member 42 rotates radial surfaces 48 and 49 sequentially engages with the exterior cylindrical side surface of the item 22 to be dispensed to speed up rotation of the stop member 42 as item 22 rolls from the storage track 20 off the front of the storage rack 18 to the dispensing station 24. The difference in the position of surfaces 46, 48 and 49 causes the stop member 42 to rotate at a first speed as item 22 engages stop surface 46 and initially starts to roll from the storage track 20 and then speeds up when the item 22 sequentially engages with surfaces 48 and 49 as the item continues to roll from the front 21 of the storage rack 18. Engagement of item 22 with surfaces 48 and 49 of the stop member 42 moves the next arm 44 into a position in which the next arm 44 blocks movement of additional items 22 from the storage track 20. Surface 46 is disposed approximately 140 degrees from the surface 48 as is illustrated in FIG. 5. Assuming an item 22 to be dispensed rolls from storage track 20 at a substantially constant speed, the item 22 initially engages radial surface 46 and then subsequently engages surfaces 48 and 49 on stop member 42. The difference in position of surfaces 46, 48 causes the item 22 to speed up rotation of stop member 42 when item 22 engages with radial surfaces 48 and 49. Speeding up rotation of stop member 42 prevents more than one item 22 from being dispensed at one time and prevents jamming of the stop member 42 by the next item 22 to be dispensed.

A pair of springs 58 bias latch member 54 towards its latched position. The springs 58 are connected at one end to support member 43 and at the opposite end to latch member 54 to bias latch member 54 to the left, as viewed in FIGS. 6-9, against any biasing force of the solenoid 56. Energization of solenoid 56 overcomes the biasing force of springs 58 and moves latch member 54 in a direction away from axis 50 to disengage latch member 54 from the latching surface 52 on the stop member 42. When solenoid 56 is deenergized springs 58 bias the latch member 54 back toward its latched position, illustrated in FIG. 7, in which the latch member 54 is operable to engage with the surface 52 of the stop member 42. It should be appreciated that the solenoid 56 only needs to be momentarily energized to disengage latch 54 from surface 52 of the stop member 42 to provide for initial rotation of the stop member 42 and dispensing of a single item 22 from the storage track 20. After stop member 42 is rotated approximately 5 degrees, or approximately 125 milliseconds after the solenoid 56 is energized, the solenoid 56 can be deenergized to allow latch member 54 to return to its latched position where it will eventually reengage with stop member 42 as stop member 42 continues to rotate as an item 22 continues to roll from storage track 20.

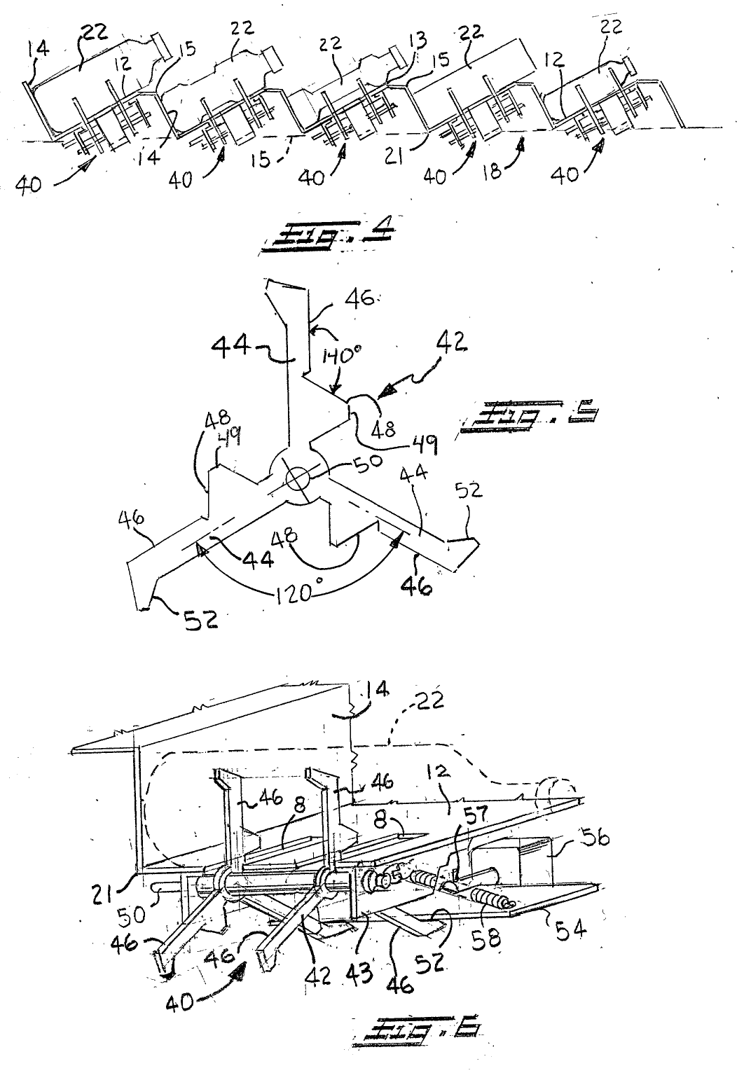

Each of the plurality of storage tracks 20 includes first and second elongate planar surfaces 12 and 14. The first and second elongate planar surfaces are disposed substantially perpendicular to each other and are inclined in a downwardly direction, approximately 12 degrees, from the back 19 of the storage rack 18 toward the front 21 of the storage rack. Each of the first and second elongate planar surfaces 12 and 14, as is more fully schematically illustrated in FIG. 3, are disposed at an acute angle “A” to a horizontal plane 15 disposed substantially parallel to the ground. Surface 12 is disposed at approximately 28 degrees to plane 15 and surface 14 is disposed at approximately 62 degrees to plane 15. Each of the parallel storage tracks 20 are operable to support a plurality of items 22 to be dispensed with the substantially cylindrical side surface of each item 22 being rollingly supported on the first planar surface 12 of each track 20 and the bottom surface of each item 22 being supported and registered on the second planar surface 14 of each track 20. The items 22 to be dispensed are supported in each of the tracks 20 and roll on their cylindrical side surface on the first elongate planar surface 12 in a downwardly direction from the back 19 of the storage rack 18 to the front 21 of the storage rack 18 where the item 22 engages with the stop member 42. The planar surface 12 includes a pair of channels 8 to accommodate arms 44 of the stop member 42. A guide member 27 is attached to the front 21 of each of the storage tracks 20 to guide movement of the items 22 to be dispensed from the storage tracks to the dispensing station 24.

The first elongate surface 12 includes a first elongate edge 13 disclosed in FIGS. 2 and 3 and the second elongate planar surface 14 includes a first elongate edge 15 which is disposed contiguous to the first elongate edge 13 of the first planar surface 12. While an embodiment of the invention has been disclosed in which the first elongate edge 13 of the first elongate planar surface 12 is disposed contiguous to the first elongate edge is of the second planar surface 14, it should be appreciated that the elongate edges 13, 15 do not necessarily have to be disposed contiguous to each other for the storage rack 18 and/or vending machine 10 to come within the scope of the present invention. For example, FIG. 4 discloses an alternate embodiment of the invention in which the first elongate edge 13 of the first elongate planar 12 surface is not disposed contiguous to the first elongate edge 15 of the second planar surface 14.

Each of the items 22 to be dispensed includes a substantially flat bottom surface 23 and a side surface 25 which is substantially cylindrical in shape regardless of the width and/or combination of vertical curves. The storage tracks 20 of the present invention are operable to store and dispense a plurality of items 22 of various shapes, widths, lengths, and sizes without modification of the storage racks 18 or storage tracks 20. As is noted in FIGS. 2 and 3 the width, and/or height of the containers 22 to be dispensed can vary and still be accommodated in the storage tracks 20. In addition, the general shape of the container or item 22 and the width of the opening in the container can vary widely and still be accommodated in the storage track 20 as long as the container 22 has a substantially flat bottom surface 23 which is disposed substantially perpendicular to a substantially cylindrical side surface 25 of the item 22. While the width of the item 22 to be dispensed generally cannot be wider than the width of the elongate planar surface 14 which accommodates the bottom 23 of the item 22 to be dispensed to prevent interference between items 22 in adjacent tracks 20, it should be apparent that in some instances items 22 having a width wider than surface 14 could be accommodated in some of the tracks 20 depending on the shape of the items 22 to be vended in the adjacent tracks and depending on the particular track 20 chosen. For example, in FIG. 2 or FIG. 3, the left most track 20 could be utilized to accommodate an item 22 such as a potato chip container, having a width which is larger than the width of surface 14 because there is not an adjacent track to the left in the figures which would hold items which would interfere with the wide chip can. Additionally, items 22 which are wider than surface 14 could be accommodated in a track 20 provided the width of the item 22 does not engage with and interfere with movement of items 22 in adjacent tracks. For example, a wide item such as the potato chip can be illustrated in FIGS. 2 and 3 could be accommodated in a center track 20 if adjacent items 22 had a tapered configuration on both adjacent tracks 20. Additionally, as is illustrated in FIG. 2, each track 20 can accommodate, simultaneously, different shaped items 22.

As an example, and without limiting, FIGS. 2 and 3 discloses vending of various items 22 such as potato chips which are disposed in a round cylindrical cardboard container 22a, a soda or beer can 22b having a standard configuration, a plastic milk container 22c having a cylindrical curved side wall, a plastic water bottle 22d having a cylindrical side wall, and a glass juice bottle 22e also having a cylindrical side wall. It is noted that the width of the various containers 22 to be vended varies, as does the height, cross sectional configuration, and opening therein. As is illustrated, the storage racks 18 and storage tracks 20 are adapted to accommodate and dispense a large number of containers 22 of various shapes and sizes without making special adaptations to the machine and/or the storage rack 20.

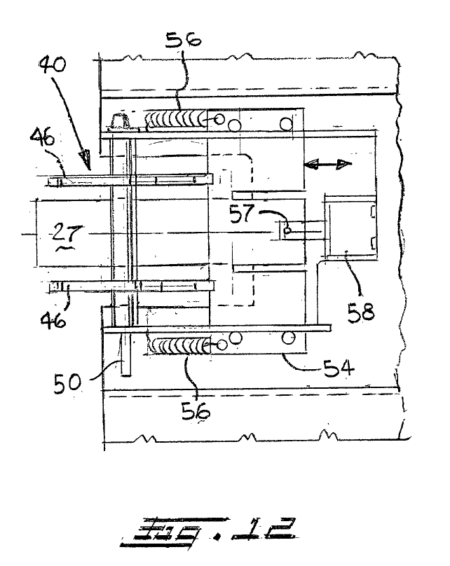

While the preferred embodiment of the invention has been illustrated in a vending machine 10 in which items 22 are sequentially vended after a credit of a predetermined amount has been received in the machine 10, it should be appreciated that the storage rack 18 of the present invention is equally adaptable to a merchandiser which supports a plurality of items 22 in the storage tracks 20 of each of the storage racks 18. A merchandiser differs from a vending machine in that in a merchandiser a product 22 can be removed from the storage cabinet 16 without paying via a credit mechanism 32. In a merchandiser, when it is desired to dispense an item 22, the door 26 is opened and a customer removes the desired product 22 from a selected storage track 20 in a storage rack 18. In such a merchandising machine, a stop member 60, such as illustrated in FIGS. 10 and 11, can be utilized to prevent the items 22 from sliding out of the front 21 of the storage tracks 20. The stop member 60 can be a single member or can be a pair of spaced apart stop members 60 as is illustrated in FIGS. 11 and 12 formed from a resilient material such as rubber, neoprene or plastic. The resilient stop member 60 prevents items 22 from rolling from the front 21 of the storage tracks 20. When a customer desires to remove an item 22 from the storage track 20 of a merchandiser, the door 26 is opened, the item 22 is grasped by the customer and the resilient stop member 60 is overcome by the customer moving the item 22 to allow the item to be removed from the storage track 20. The next item in the storage track then rolls forward toward the front 21 of the storage track 20 to engage the resilient stop member 60 to be removed by the next customer. As used herein, the term dispensing shall refer to either a vending machine and/or a merchandising machine.

From the foregoing, it should be apparent that a new and improved dispensing machine 10 for dispensing a plurality of items 22 each of which has a substantially cylindrical side surface 25 and a flat bottom surface 23 disposed substantially perpendicular to the side surface 25 has been disclosed. The machine 10 includes a storage cabinet 16 having a plurality of storage racks 18 supported therein for supporting items 22 to be dispensed. Each of the storage racks 18 includes a front 21, a back 19, and a plurality of substantially parallel storage tracks 20 with each storage track being formed by first and second elongate planar surfaces 12 and 14 which are disposed substantially perpendicular to each other and which are inclined in a downwardly direction from the back 19 of the storage rack 18 toward the front 21 of the storage rack 18 with each of the first and second elongate planar surfaces being disposed at an acute angle to a horizontal plane 15 disposed substantially parallel to the ground. Each of the storage tracks 20 is operable to support a plurality of items 22 with the flat bottom surface 23 of the item 22 supported and registered on one of the first and second elongate planar surfaces 12, 14 and the cylindrical side surface 25 of the item being rolling supported on the other of the first and second elongate planar surfaces 12 and 14. A stop member such as the stop member 42 or the stop member 60 is provided adjacent to the front 21 of the storage rack 18 for engaging with items 22 to be dispensed to prevent the items from rolling from the storage tracks 20.

What I claim is:

1. A storage rack for supporting a plurality of items to be dispensed each of which includes a substantially cylindrical side surface and a substantially flat bottom surface disposed substantially perpendicular to said cylindrical side surface, said storage rack comprising a front, a back, and a plurality of substantially parallel tracks extending from the back of the storage rack to the front of the storage rack each of which is inclined in a downwardly direction from said back of said storage rack to said front of said storage rack, each of said plurality of tracks including a first elongated planar surface and a second elongate planar surface disposed substantially perpendicular to said first elongate planar surface, said first and second planar surfaces being inclined in a downwardly direction from said back of said storage rack to said front of said storage rack, and wherein said first and second planar surfaces each form an acute angle with a horizontal plane parallel to the ground, and a stop member located at the end of each of said tracks adjacent to said front of the storage rack, each of said parallel tracks being operable to support a plurality of items to be dispensed with the substantially cylindrical side surface of each item being rollingly supported on said first planar surface of said track and the bottom surface of each item being supported on said second planar surface, each of the items to be dispensed being supported in said track and rolling on said cylindrical side surface on said first planar surface in a downwardly direction from the back of the storage rack to the front of the storage rack wherein said item engages with said stop member.

2. A storage rack for supporting a plurality of items to be dispensed as defined in claim 1 wherein said first elongate planar surface has a first elongate edge, said second elongate planar surface has a first elongate edge and said first elongate edge of said first planar surface is disposed contiguous to said first elongate edge of said second planar surface.

3. A storage rack for supporting a plurality of items to be dispensed as defined in claim 1 wherein said stop member engages items to be dispensed in said track and stops the items from rolling from the track off the front of the storage rack.

4. A storage rack for supporting a plurality of items to be dispensed as defined in claim 3 wherein said stop member is movable from a blocking position in which said stop member blocks items from rolling from said track off the front of said storage rack to a position in which said stop member enables an item to be dispensed from said track off the front of said storage rack.

5. A storage rack for supporting a plurality of items to be dispensed as defined in claim 4 further including a latch for latching said stop member in said blocking position and for unlatching said stop member to enable said stop member to move from said blocking position to dispense a single item from said track.

6. A storage rack for supporting a plurality of items to be dispensed as defined in claim 5 further including a solenoid for moving said latch between a position in which said latch latches said stop member and a position in which said latch unlatches said stop member to cause an item to be dispensed to roll under the influence of gravity from the track past the unlatched stop member.

7. A storage rack for supporting a plurality of items to be dispensed as defined in claim 6 wherein said stop member is rotatable about an axis disposed substantially parallel to said first elongate planar surface of said track.

8. A storage rack for supporting a plurality of items to be dispensed as defined in claim 7 wherein said stop member includes three legs each of which extends in a radial direction from said axis, each leg being spaced apart from an adjacent leg approximately 120° about said axis.

9. A storage rack for supporting a plurality of items to be dispensed as defined in claim 8 wherein one of said legs of said stop member when in said blocking position is adapted to engage with an item to be dispensed to prevent said item from rolling off the front of said track and another of said legs is simultaneously engageable with said latch to prevent rotation of said stop member about said axis when said latch is engaged therewith.

10. A storage rack for supporting a plurality of items to be dispensed as defined in claim 3 wherein said stop member is rotatable about an axis disposed substantially parallel to said first elongate planar surface of said track.

11. A storage rack for supporting a plurality of items to be dispensed as defined in claim 10 wherein said stop member includes three legs each of which extends in a radial direction from said axis, each leg being spaced apart from an adjacent leg approximately 120° about said axis.

12. A storage rack for supporting a plurality of items to be dispensed as defined in claim 1 wherein the first elongate planar surfaces of adjacent tracks in said storage rack are disposed substantially parallel to each other and spaced apart a distance greater than the diameter of the substantially cylindrical side surface of the item to be dispensed.

13. A storage rack for supporting a plurality of items to be dispensed as defined in claim 9 wherein each of said legs of said stop member include a first radial surface which is engageable with said cylindrical side surface of the item to be dispensed to block movement of the item from the track and a second radial surface which is engageable with the cylindrical side surface of the item to be dispensed after said latch is released and the item to be dispensed rolls against said first radial surface to rotate said legs about said axis, said second radial surface when engaging with the cylindrical side surface of the item to be dispensed accelerating rotation of said stop member about said axis.

14. A storage rack for supporting a plurality of items to be dispensed as defined in claim 4, wherein said stop member is rotatable about an axis and includes a plurality of spaced apart legs each of which extends in a radial direction from said axis, each of said legs having a first radial surface which is engageable with the cylindrical side surface of an item to be dispensed to block movement of the item from said storage track and a second radial surface which is engageable with the cylindrical side surface of the item to be dispensed after the item to be dispensed rolls against said first radial surface to rotate said spaced apart legs about said axis, said second radial surface when engaging with the cylindrical side surface of the item to be dispensed accelerating rotation of the stop member about said axis.

15. A vending machine for vending a plurality of items each of which has a substantially cylindrical side surface and a flat bottom surface disposed substantially perpendicular to said side wall, said vending machine comprising a storage cabinet, a plurality of storage racks supported in said storage cabinet for supporting items to be dispensed, each of said storage racks having a front, a back, and a plurality of substantially parallel storage tracks located therein, each storage track being formed by first and second elongate planar surfaces which are disposed substantially perpendicular to each other and which are inclined in a downwardly direction from the back of the storage rack toward said front of said storage rack with each of said first and second elongate planar surfaces being disposed at an acute angle to a horizontal plane disposed parallel to the ground, each of said storage tracks being operable to support a plurality of said items with the flat bottom surface of the item supported on one of said first and second elongate planar surfaces and the cylindrical side surface of the item being rollingly supported on the other of said first and second elongate planar surfaces.

16. A vending machine for vending a plurality of items as defined in claim 15 further including a stop member located at the end of each of said storage tracks adjacent to said front of said storage racks for engaging with items to be disposed to prevent said items from rolling from said track off the front of said storage rack.

17. A vending machine for vending a plurality of items as defined in claim 15 wherein said other of said first and second elongate planar surfaces which rollingly supports the cylindrical side surface of each of the items to be dispensed is disposed parallel to the other elongate planar surface of each adjacent track and is spaced apart from adjacent other elongate planar surfaces a distance greater than the diameter of the substantially cylindrical side surface of the item to be dispensed.

18. A vending machine for vending a plurality of items as defined in claim 16 wherein said stop member is movable from a blocking position in which said stop member blocks items from rolling from said track off the front of said storage rack to a position in which said stop member enables an item to be dispensed from said track off the front of said storage rack.

19. A vending machine for vending a plurality of items as defined in claim 18 further including a latch for latching said stop member in said blocking position and for unlatching said stop member to enable said stop member to move from said blocking position to dispense a single item from said track.

20. A vending machine for vending a plurality of items as defined in claim 19 further including a solenoid for moving said latch between a position in which said latch latches said stop member and a position in which said latch unlatches said stop member to cause an item to be dispensed to roll under the influence of gravity from the track past the unlatched stop member.

21. A vending machine for vending a plurality of items as defined in claim 20 wherein said stop member is rotatable about an axis disposed substantially parallel to said first elongate planar surface of said track.

22. A vending machine for vending a plurality of items as defined in claim 21 wherein said stop member includes three legs each of which extends in a radial direction from said axis, each leg being spaced apart from an adjacent leg approximately 120° about said axis.

23. A vending machine for vending a plurality of items as defined in claim 22 wherein each of said legs of said stop member include a first radial surface which is engageable with said cylindrical side surface of the item to be dispensed to block movement of the item from the track and a second radial surface which is engageable with the cylindrical side surface of the item to be dispensed after said latch is released and the item to be dispensed rolls against said first radial surface to rotate said legs about said axis, said second radial surface when engaging with the cylindrical side surface of the item to be dispensed accelerating rotation of said stop member about said axis.

24. A vending machine for vending a plurality of items as defined in claim 22 wherein one of said legs of said stop member when in said blocking position is adapted to engage with an item to be dispensed to prevent said item from rolling off the front of said track and another of said legs is simultaneously engageable with said latch to prevent rotation of said stop member about said axis when said latch is engaged therewith.
